(19) United States
(12) Patent Application Publication
(10) Pub. No.: US 2007/0004413 A1
(43) Pub. Date: Jan. 4, 2007

(54) Network support for service denial based on speed of mobile station

(75) Inventors: Sanjeev Mahajan, Naperville, IL (US); David S. Benco, Winfield, IL (US); Baoling S. Sheen, Naperville, IL (US); Sandra Lynn True, St. Charles, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc.

(21) Appl. No.: 11/170,388

(22) Filed: Jun. 29, 2005

(51) Int. Cl. H04Q 7/20

(52) U.S. Cl. 455/441; 455/421

(57) ABSTRACT

A method is provided for supporting a speed-based denial of service feature (30) in a telecommunications network (A). The method includes: determining a speed of a mobile station (40) served by a facility (20) of the telecommunications network (A); determining a threshold; and, denying the mobile station (40) service when the speed of the mobile station (40) exceeds the threshold.

### FIELD

The present inventive subject matter relates to the telecommunication arts. Particular application is found in conjunction with certain types of telecommunication networks and/or facilities, and the specification makes particular reference thereto. However, it is to be appreciated that aspects of the present inventive subject matter are also amenable to other like applications, networks and/or facilities.

### BACKGROUND

Using a mobile telephone to place or receive a call, participating in a mobile telephone call, and/or other activities one may chose to engage in with their mobile telephone, typically involve a certain amount of concentration on the task by the individual so engaged. In some instances, engaging in the operation or use of one's mobile telephone can distract the user from another task being simultaneously performed. Accordingly, the performance of other task may suffer from the lack of attention thereto. Where the other task involves certain dangers, e.g., that may be enhanced by a lack of attention, preferably, individuals would direct most if not all of their attention to the other task and forego the distraction presented by operation and/or use of their mobile telephone.

Nevertheless, many individuals still insist on operating and/or using their mobile telephones while driving or otherwise operating a motor vehicle despite the associated risks. These risks may be even further exacerbated when the motor vehicle is being operated at a high rate of speed or in excess of a posted speed limit.

In some places, an attempt has been made to deter undesirable behaviors, e.g., by enacting laws that prohibit simultaneous use of a mobile telephone while operating a motor vehicle. While the law may punish those who disobey it and/or deter others from engaging in the outlawed behavior, it does not prevent individuals from choosing to engage in the behavior. Therefore, it is advantageous to have a mechanism for regulating an individuals ability to use a mobile telecommunications device under certain circumstances, e.g., when operating a motor vehicle.

Accordingly, a new and improved telecommunications feature for denying service to a mobile station based upon its speed is disclosed that overcomes the above-referenced problems and others.

### SUMMARY

In accordance with one embodiment, a method is provided for supporting a speed-based denial of service feature in a telecommunications network. The method includes: determining a speed of a mobile station (MS) served by a facility of the telecommunications network; determining a threshold; and, denying the MS service when the speed of the MS exceeds the threshold.

In accordance with another embodiment, a system for supporting a speed-based denial of service feature in a telecommunications network includes: speed determination means for determining a speed of a mobile station (MS) served by a facility of the telecommunications network; threshold determination means for determining a threshold for the MS; and, service denial means for denying the MS service when the speed of the MS exceeds the threshold for the MS.

In accordance with yet another embodiment, a mobile switching center (MSC) is operatively connected to a telecommunications network and one or more base stations. The MSC selectively provides telecommunication services to a mobile station (MS) operatively connecting to the MSC via one or more of the base stations. Suitably, the MSC includes an application server that provides a denial of service feature to a subscriber employing the MS. The feature is operative to: determine a speed of the mobile station (MS); and, deny the MS service based upon the determined speed of the MS.

Numerous advantages and benefits of the inventive subject matter disclosed herein will become apparent to those of ordinary skill in the art upon reading and understanding the present specification.

### BRIEF DESCRIPTION OF THE DRAWINGS

The inventive subject matter may take form in various components and arrangements of components, and in various steps and arrangements of steps. The drawings are only for purposes of illustrating preferred embodiments and are not to be construed as limiting. Further, it is to be appreciated that the drawings are not to scale.

FIG. 1 is a block diagram illustrating an exemplary telecommunications network suitable for practicing aspects of the present inventive subject matter.

FIG. 2 is a flow chart showing an exemplary process embodying aspects of the present inventive subject matter.

### DETAILED DESCRIPTION OF PREFERRED EMBODIMENTS

For clarity and simplicity, the present specification shall refer to structural and/or functional elements, entities and/or facilities, relevant communication standards, protocols and/or services, and other components that are commonly known in the telecommunications art without further detailed explanation as to their configuration or operation except to the extent they have been modified or altered in accordance with and/or to accommodate the preferred embodiment(s) presented herein.

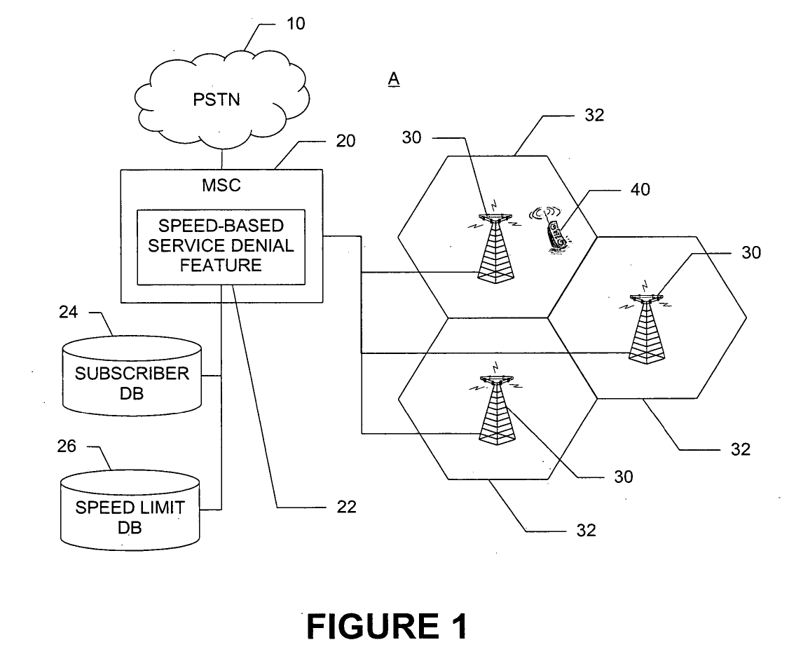

With reference to FIG. 1, a telecommunications network A includes a public switched telephone network 10 operatively connected to and/or in communication with a mobile switching center (MSC) 20 in the usual manner. The MSC 20 is operatively connected to and/or in communication with a plurality of base stations (BS) 30 in the usual manner. As is understood in the art, each BS 30 provides an over-the-air radio frequency interface for its respective geographic area or cell 32. Selectively, a mobile station (MS) 40 (e.g., in the form of a mobile telephone or any other suitable wireless end user terminal) is provided telecommunication services and/or otherwise accesses the network A via the interface and/or BS 30 serving the cell 32 in which the MS 40 is located.

While only one MSC is illustrated in FIG. 1 for purposes of simplification and clarity, it is to be appreciated that the network A may in fact include any number of one or more MSCs that are similarly situated and/or arranged. Additionally, while three BS 30 and three corresponding cells 32 are illustrated in FIG. 1, it is to be appreciated that more or less than three base stations and/or cells may be similarly situated with respect to any of the one or more MSCs in the network A. That is to say, each MSC in the network A may optionally serve any number of one or more base stations and/or corresponding cells. Additionally, while only one exemplary MS is illustrated in FIG. 1, the network A optionally serves any number of one or more mobile stations similarly situated and/or arranged in any of the one or more cells 32.

As illustrated, the MSC 20 includes or has access to a speed-based denial of service feature 22 that is selectively employed to deny the MS 40 service or access to the network A. Suitably, the feature 22 is implemented via a program and/or other appropriate software running on an application server, however, it may alternately be implemented in any suitable fashion and/or on another suitable platform or equipment. Optionally, the feature 22 is only made available to a user of the MS 40 if they have a proper subscription thereto. Moreover, the feature is optionally activated or deactivated by the subscriber as desired. Accordingly, subscription and/or activation information is maintained in a subscriber DB 24 which is queried by the MSC 20 to determine the subscription and/or activation status prior to actual implementation of the feature 22. For example, the subscriber DB 24 optionally has a list stored therein, and/or otherwise maintains data or information that indicates, which MS and/or users served by the MSC 20 (e.g., identified by their telephone numbers or other like identifiers) do and/or do not subscribe to the feature 22, and whether or not at a given instance the feature 22 is activated or deactivated.

Assuming the feature 22 is active, the MS 40 is selectively denied service or access to the network A based upon its measured or otherwise determined speed or velocity. Suitably, to determine or measure the speed of the MS 40, two or more location measurements are taken over a period of time. That is to say, the geographic location (i.e., geo-location) of the MS 40 is detected or otherwise determined at two or more times separated by some set or otherwise known time interval. As can be appreciated, the speed is then readily calculated or determined by taking the difference between two detected locations (i.e., the distance traveled by the MS 40) and dividing that result by the time interval between location measurements (i.e., the amount of time it took the MS 40 to travel the distance). Optionally, a plurality of speed measurements or determinations are taken from which an average speed, median speed, mean speed or some otherwise weight representation of the actual speed is determined or calculated and used as the speed of the MS 40 by the feature 22.

Suitably, any one or more of various known techniques are used to measure or detect the current location of the MS 40. For example, the MS 40 is optionally equipped with a global positioning system (GPS) receiver or other like device from which the geo-location of the MS 40 is obtained. Alternately, a network or MS-based technique is employed to determine or measure the geo-location of the MS 40, e.g., using the over-the-air interface and/or signals exchanged with one or more of the BS 30. For example, suitable known network and/or MS-based solutions for determining the geo-location of the MS 40 include, without limitation: observed time difference (OTD); time of arrival (TOA); time difference of arrival (TDOA); angle of arrival (AOA); multipath fingerprinting; timing advance (TA); enhanced forward link triangulation (EFLT); received signal strength (RSS); etc. Optionally, a hybrid geo-location determination solution combining one or more of the aforementioned techniques is employed or so-called assisted-GPS may also be employed.

Optionally, while the MS 40 is being used to participate in a call, the feature 22 monitors the speed of the MS 40. If the speed is detected to exceed a set or otherwise determined threshold, suitably, the MS 40 is sent an initial warning indicating that an excessive speed has been detected. For example, a recording or message is optionally played or sent to the MS 40 indicating that the call will be dropped or ended if the excessive speed is not reduced. After the user is given a sufficient amount of time in which to comply, if the monitored speed of the MS 40 is not reduced to an acceptable level (e.g., below the threshold), the call is in fact dropped, optionally, after again indicating to the user why the call is being dropped. Alternately, of course, the call is optionally dropped without any initial warning the first time excessive speed is detected. In still another alternate embodiment, multiple warnings optionally precede actual dropping of the call.

With respect to call origination, optionally, the feature 22 determines the speed of the MS 40 prior to permitting a call to originate from the MS 40. If the speed exceeds the set or otherwise determined threshold, suitably, service is denied to the MS 40. Rather, the MS 40 is optionally played or sent a recording or message indicating why the MS 40 is being denied service. Similarly, with respect to call termination, optionally, the feature 22 determines the speed of the MS 40 prior to connecting or delivering a call to the MS 40 or otherwise prior to alerting the MS 40 of an incoming call. If the speed exceeds the set or otherwise determined threshold, suitably, service is again denied to the MS 40. That is to say, the call is not connected to the MS 40 and/or the MS. 40 is not alerted of the incoming call. Optionally, the calling party is treated as if the call was not answered in the normal fashion or as if the MS 40 was not able to be located. Additionally, a voicemail or message is also optionally sent to the subscriber's corresponding mailbox or missed call list indicating that the incoming call had been missed and/or why the MS 40 was denied service.

Suitably, the threshold employed by the feature 22 is set or determined to correspond with a posted or otherwise legal speed limit for the current geo-location of the MS 40. For example, as illustrated, a speed limit look-up-table or DB 26 is programmed or provisioned with the speed limits for various geo-locations corresponding to roadways, etc. That is to say, the different speed limits are cross-referenced to the respective geo-locations where those speed limits are posted or otherwise applicable. Accordingly, the feature 22 accesses the DB 26 using the detected or determined geo-location of the MS 40 as an index or the like to obtain the corresponding speed limit for that geo-location from the DB 26. The obtained speed limit is then used as the threshold against which the monitored or detected speed of the MS 40 is compared.

Optionally, in certain locations, e.g., in cities or on roadways where operating a motor vehicle while talking or otherwise operating a mobile telephone is restricted or prohibited, the speed threshold used by the feature 22 is set to or near zero. For example, such geo-locations in the DB 26 are optionally associated with a zero or near zero speed limit. In this manner, if any speed over the zero or near zero threshold (i.e., any speed sufficiently fast enough to indicate motor vehicle operation) is detected, then service is denied to the MS 40. Alternately, the threshold is optionally set by the subscriber to a desired level. For example, the subscriber set threshold is optionally maintained in the subscriber DB 24 with their other subscription information. Accordingly, the feature 22 access the DB 24 to obtain the speed threshold that is applied for the MS 40. In this manner, e.g., the subscriber can optionally choose to prohibit use of the MS 40 while operating a motor vehicle by setting the threshold sufficiently low.

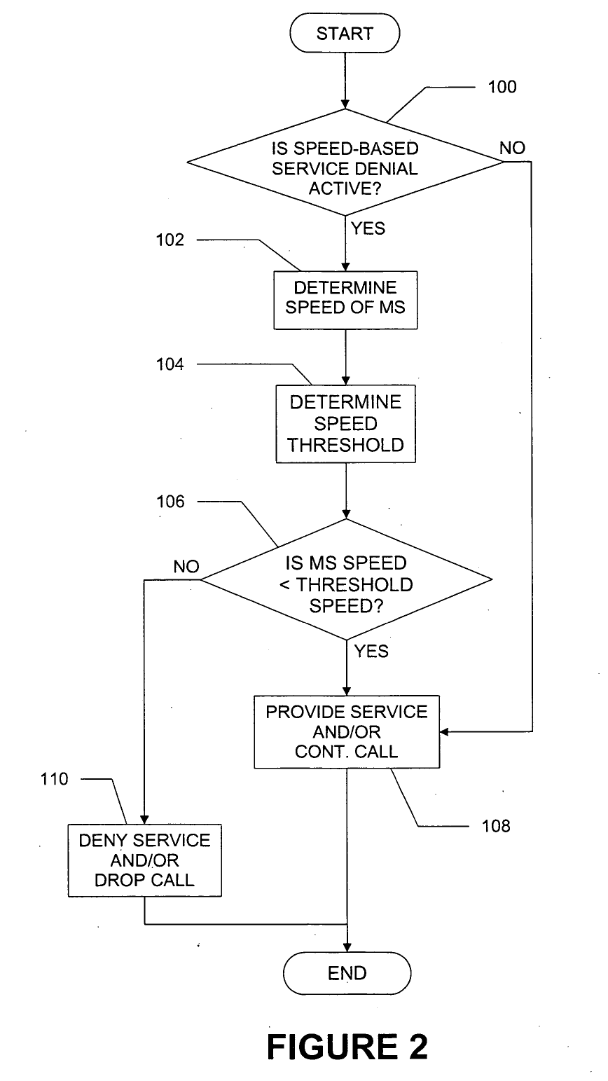

With reference to FIG. 2, an exemplary process illustrating the operation of the speed-based service denial feature 22 will now be described. The process starts at decision step 100 where it is determined if the user of the MS 40 has a proper subscription to the feature 22 and/or if the feature 22 is activated. Suitably, the facility 20 queries the DB 24 to obtain the relevant subscription and/or activation status for the MS 40 or its user. If there is no subscription or the feature 22 is not activated for the MS 40, then the process jumps ahead to step 108 wherein call handling is conducted normally, i.e., regardless of the speed of the MS 40. That is to say, at step 108, the MS 40 is permitted continue on calls already in progress, originate new calls, receive in-coming calls, etc. Otherwise, if there is a proper subscription and/or that the feature 22 is activated for the MS 40, then the process continues to step 102.

At step 102, the speed of the MS 40 is detected or otherwise determined. For example, the geo-location of MS 40 is detected or otherwise determined at least twice. Suitably, the location measurements or determinations are taken at two different times separated by a time interval. The speed of the MS 40 is then determined by calculating the difference in location between two of the geo-location measurements divided by the time interval there between. Optionally, the speed of the MS 40 is determined to be an average, median, mean or otherwise weighted combination of multiple speed measurements.

At step 104, a speed threshold is determined. For example, the speed threshold is optionally set by the subscriber and acquired or obtained by the feature 22 from the subscriber DB 24. Alternately, the speed threshold is acquired or obtained by the feature 22 from the speed limit DB 26 which relates speed limits to geo-locations. Suitably, the most recently obtained geo-location for the MS 40 (e.g., one of the same ones used in the speed determination step 102) is used as an index or the like to selected the speed limit from the DB 26 that corresponds to the current geo-location of the MS 40.

At decision step 106, the speed of the MS 40 obtained in step 102 is compared to the threshold speed obtained in step 104. If the speed of the MS 40 does not exceed the threshold speed (i.e., the speed of the MS 40 is less than the threshold speed), then the process continues on to step 108, where call handling is processed otherwise normally, e.g., the MS 40 is permitted continue on calls already in progress, originate new calls, receive in-coming calls, etc. Otherwise, if the speed of the MS 40 does exceed the threshold speed (i.e., the speed of the MS 40 is greater than the threshold speed), then the process branches to step 110. At step 110, service is denied to the MS 40, e.g., calls already in progress on the MS 40 are dropped, calls are denied origination from the MS 40, in-coming calls are not connected or delivered to the MS 40 and/or the MS 40 is not alerted for in-coming calls, etc.

It is to be appreciated that in connection with the particular exemplary embodiments presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

What is claimed is:

1. A method for supporting a speed-based denial of service feature in a telecommunications network, said method comprising:
(a) determining a speed of a mobile station (MS) served by a facility of the telecommunications network;
(b) determining a threshold; and,
(c) denying the MS service when the speed of the MS exceeds the threshold.

2. The method of claim 1, wherein step (a) comprises:
determining a first location of the MS at a first time; and,
determining a second location of the MS at a second time spaced from the first time by a time interval.

3. The method of claim 2, wherein step (a) further comprises:
determined a distance between the first and second locations; and,
dividing the distance by the time interval.

4. The method of claim 1, wherein step (b) comprises:
obtaining the threshold from a database, said threshold having been set by a user and stored in the database.

5. The method of claim 1, wherein step (b) comprises:
maintaining a database in which speed limits are associated with locations where the speed limits are applicable;
determining a location of the MS; and,
selecting as the threshold the speed limit from the database corresponding to the location of the MS.

6. The method of claim 1, wherein step (c) comprises:
at least one of: dropping a call currently in progress on the MS; blocking a call origination from the MS; or blocking a call termination to the MS.

7. A system for supporting a speed-based denial of service feature in a telecommunications network, said system comprising:
speed determination means for determining a speed of a mobile station (MS) served by a facility of the telecommunications network;
threshold determination means for determining a threshold for the MS; and,
service denial means for denying the MS service when the speed of the MS exceeds the threshold for the MS.

8. The system of claim 1, wherein the speed determination means comprises:
location determination means for determining a first location of the MS at a first time; and, determining a second location of the MS at a second time spaced from the first time by a time interval.

9. The system of claim 2, wherein the speed determination means further comprises:
distance determination means for determined a distance between the first and second locations; and,
calculating means for dividing the distance by the time interval.

10. The system of claim 1, further comprising:
a database in which a user set threshold is stored for the MS, said threshold determination means selecting the threshold from the database which corresponds to the MS.

11. The system of claim 1, further comprising:
a database in which speed limits are associated with locations where the speed limits are applicable; and,
location determination means for determining a location of the MS;
wherein the threshold determination means selects as the threshold for the MS the speed limit from the database corresponding to the location of the MS.

12. The system of claim 1, wherein the service denial means operates to achieve at least one of the following: dropping a call currently in progress on the MS; blocking a call origination from the MS; or blocking a call termination to the MS.

13. A mobile switching center (MSC) operatively connected to a telecommunications network and one or more base stations, said MSC selectively providing telecommunication services to a mobile station (MS) operatively connecting to the MSC via one or more of the base stations, said MSC comprising:
an application server that provides a denial of service feature to a subscriber employing the MS, said feature operative to:
determine a speed of the mobile station (MS); and,
deny the MS service based upon the determined speed of the MS.

14. The MSC of claim 13, wherein the feature is operative to deny the MS service when the speed of the MS exceeds a threshold.

15. The MSC of claim 14, further comprising:
a subscriber database from which the feature obtains the threshold.

16. The MSC of claim 13, further comprising:
a location determination device that detects a location of the MS.

17. The MSC of claim 16, further comprising:
a speed limit database which relates speed limits to locations where the speed limits are applicable;
wherein said feature obtains that speed limit from the database which corresponds to the location of the MS detected by the location determination device, and said feature is operative to deny the MS service when the determined speed of the MS exceeds the obtained speed limit.

18. The MSC of claim 16, wherein the feature determines the speed of the MS by:
obtaining a first detected location of the MS from the location determination device at a first time;
obtaining a second location of the MS from the location determination device at a second time spaced from the first time by a time interval;
calculating a distance between the first and second locations; and,
dividing the difference by the time interval.

19. The MSC of claim 13, wherein when the feature denies the MS service, at least one of the following results is achieved: a call currently in progress on the MS is dropped; a call origination from the MS is blocked; or a call termination to the MS is blocked.

20. The MSC of claim 13, wherein when the feature operates to deny the MS service, a message is sent to the MS indicating a reason service was denied.
